(19) United States
(12) Patent Application Publication
(10) Pub. No.: US 2026/0100750 A1
(43) Pub. Date: Apr. 9, 2026

(54) Beam Failure Detection Monitoring

(71) Applicant: Telefonaktiebolaget LM Ericsson (publ), Stockholm (SE)

(72) Inventors: Antonino Orsino, Kirkkonummi (FI); Icaro Leonardo Da Silva, Solna (SE); Stefan Wager, Espoo (FI)

(21) Appl. No.: 19/114,216

(22) PCT Filed: Sep. 29, 2023
(86) PCT No.: PCT/SE2023/050963

§ 371 Date: Mar. 21, 2025

Related U.S. Application Data
(60) Provisional application No. 63/411,291, filed on Sep. 29, 2022.

(51) Int. Cl. H04B 7/06; H04W 24/10

(52) U.S. Cl. CPC H04B 7/06964; H04W 24/10

(57) ABSTRACT

In an example, a method performed by a user equipment (UE) for beam failure detection (BFD) monitoring is provided. The method comprises receiving, from a network node, a configuration identifying one or more Layer 1/Layer 2 (L1/L2) inter-cell mobility candidate target cells; and performing BFD monitoring on a current serving cell of the UE. The method also comprises determining BFD on the current serving cell, and performing BFR on a beam on the current serving cell or a beam on one of the one or more candidate target cells, or executing L1/L2 inter-cell mobility to a beam on one of the one or more candidate target cells.

### TECHNICAL FIELD

Examples of this disclosure relate to beam failure detection monitoring, such as for example in a User Equipment (UE) or a network node such as a Radio Access Network (RAN) node.

### BACKGROUND

### Beam Failure Detection and Recovery Procedure

In a wireless communication system, such as for example a mobile or cellular wireless communication system, a medium access control (MAC) entity may be configured by Radio Resource Control (RRC) per Serving Cell with a beam failure recovery (BFR) procedure which is used for indicating to the serving RAN node (e.g. gNodeB, gNB) of a new synchronization signal block (SSB) or channel state information-reference signal (CSI-RS) when beam failure is detected on the serving SSB(s)/CSI-RS(s). Beam failure is detected by counting beam failure instance indications from lower layers to the MAC entity. If a beamFailureRecoveryConfig beam failure recovery configuration is reconfigured by upper layers during an ongoing Random Access procedure for beam failure recovery for a Special Cell (SpCell), the MAC entity shall stop the ongoing Random Access procedure and initiate a Random Access procedure using the new configuration. The Beam Failure Detection and Recovery procedure is described in the 3rd Generation Partnership Project (3GPP) technical specification 38.321, version 17.1.0, section 5.17.

In release 18 (Rel-18), the 3rd Generation Partnership Project (3GPP) has agreed on a Work Item (WI) on Further New Radio (NR) mobility enhancements, in particular in a technical area entitled L1/L2 based inter-cell mobility. See the work item description (WID) in RP-213565, https://www.3gpp.org/ftp/TSG_RAN/TSG_RAN/TSGR_94e/Docs//RP-213565.zip for further details.

According to the WID, when the UE moves from the coverage area of one cell to another cell, at some point a serving cell change needs to be performed. Currently, serving cell change is triggered by layer 3 (L3) measurements and is done by RRC signalling triggered Reconfiguration with Synchronisation for change of primary cell (PCell) and primary secondary cell (PSCell), as well as release or add of SCells when applicable. All cases involve complete L2 and L1 resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

To support L1-L2 inter-cell mobility the UE should be configured to perform measurements on cells which are not the serving cells as defined up to Rel-17. In Rel-17, to support inter-PCI (physical cell identifier) multiple transmission and reception point (mTRP) operation, a solution has been standardized where a channel state information (CSI) resource may be associated to a PCI which is not the same PCI of one of the serving cells. That solution also requires the UE to receive an explicit indication of which beams (SSBs) and PCIs to be measured for a given reporting configuration.

The goal is to specify the following mechanisms and proceduress of L1/L2 based inter-cell mobility for mobility latency reduction:
Configuration and maintenance for multiple candidate cells to allow fast application of configurations for candidate cells [RAN2, RAN3]
Dynamic switch mechanism among candidate serving cells (including SpCell and SCell) for the potential applicable scenarios based on L1/L2 signalling [RAN2, RAN1]
L1 enhancements for inter-cell beam management, including L1 measurement and reporting, and beam indication [RAN1, RAN2]
   Note 1: Early RAN2 involvement is necessary, including the possibility of further clarifying the interaction between this bullet with the previous bullet
Timing Advance management [RAN1, RAN2]
CU-DU interface signaling to support L1/L2 mobility, if needed [RAN3]
Note 2: FR2 specific enhancements are not precluded, if any.
Note 3: The procedure of L1/L2 based inter-cell mobility are applicable to the following scenarios:
   Standalone, CA and NR-DC case with serving cell change within one CG
   Intra-DU case and intra-CU inter-DU case (applicable for Standalone and CA: no new RAN interfaces are expected)
   Both intra-frequency and inter-frequency
   Both FR1 and FR2
   Source and target cells may be synchronized or non-synchronized

There currently exist certain challenge(s). For example, there is no existing solution yet agreed in 3GPP for layer 1/layer 2 (L1/L2) inter-cell mobility. One relevant agreement in the first 3GPP meeting in which L1/L2 based inter-cell mobility was discussed (RAN2 #119-e) is the following:

*********************************************************************************************************
R2-2208199 Configuration of candidate target cells for L1/L2 based inter-cell mobility
Ericsson discussion Rel-18 NR_mob_enh2-Core

| | |
|---|---|
| [...] | |
| ⇒ | Current options on the table: to configure a L1/L2 inter-cell mobility |
| | candidate cell: |
| | a. One RRCReconfiguration message for candidate target cell |
| | b. One CellGroupConfig IE for each candidate target cell |
| | c. One SpCellConfig IE for each candidate target cell |

*********************************************************************************************************

One issue which has not been discussed is how the BFD and BFR procedure operate if the UE is configured with a serving cell and also with a set of L1/L2 inter-cell mobility candidate cells. If the legacy procedure is followed, the UE will perform BFD and BFR only on the serving cell, but this it may result in an unnecessary connectivity interruption as one or more L1/L2 inter-cell mobility candidate cells may be still suitable.

### SUMMARY

Certain embodiments may provide one or more of the following technical advantage(s). For example, example methods and solutions proposed herein may avoid the UE triggering the RRC reestablishment procedure in case there is a radio link failure (RLF) when the beam failure recovery procedure does not complete successfully. Furthermore, during the beam failure recovery procedure, a further benefit of example methods is that the BFR procedure can be avoided in case BFD is detected on the serving cell but also on one or more of the L1/L2 target candidate cells.

One aspect of the present disclosure provides a method performed by a user equipment (UE) for beam failure detection (BFD) monitoring. The method comprises receiving, from a network node, a configuration identifying one or more Layer 1/Layer 2 (L1/L2) inter-cell mobility candidate target cells, and performing BFD monitoring on a current serving cell of the UE. The method also comprises determining BFD on the current serving cell, and performing BFR on a beam on the current serving cell or a beam on one of the one or more candidate target cells, or executing L1/L2 inter-cell mobility to a beam on one of the one or more candidate target cells.

Another aspect of the present disclosure provides a method performed by a network node for configuring a user equipment (UE) for beam failure detection (BFD) monitoring. The method comprises sending, to the UE, a configuration identifying one or more Layer 1/Layer 2 (L1/L2) inter-cell mobility candidate target cells. The configuration identifies one or more actions to be performed by the UE with respect to each candidate target cell on determining BFD on the current serving cell and/or the one or more candidate target cells.

A further aspect of the present disclosure provides user equipment (UE) for beam failure detection (BFD) monitoring. The UE comprises a processor and a memory. The memory contains instructions executable by the processor such that the UE is operable to receive, from a network node, a configuration identifying one or more Layer 1/Layer 2 (L1/L2) inter-cell mobility candidate target cells; perform BFD monitoring on a current serving cell of the UE; determine BFD on the current serving cell; and perform BFR on a beam on the current serving cell or a beam on one of the one or more candidate target cells, or execute L1/L2 inter-cell mobility to a beam on one of the one or more candidate target cells.

A still further aspect of the present disclosure provides a network node for configuring a user equipment (UE) for beam failure detection (BFD) monitoring. The network node comprises a processor and a memory. The memory contains instructions executable by the processor such that the network node is operable to send, to the UE, a configuration identifying one or more Layer 1/Layer 2 (L1/L2) inter-cell mobility candidate target cells. The configuration identifies one or more actions to be performed by the UE with respect to each candidate target cell on determining BFD on the current serving cell and/or the one or more candidate target cells.

An additional aspect of the present disclosure provides a user equipment (UE) for beam failure detection (BFD) monitoring. The UE is configured to receive, from a network node, a configuration identifying one or more Layer 1/Layer 2 (L1/L2) inter-cell mobility candidate target cells; perform BFD monitoring on a current serving cell of the UE; determine BFD on the current serving cell; and perform BFR on a beam on the current serving cell or a beam on one of the one or more candidate target cells, or execute L1/L2 inter-cell mobility to a beam on one of the one or more candidate target cells.

Another aspect of the present disclosure provides a network node for configuring a user equipment (UE) for beam failure detection (BFD) monitoring. The network node is configured to send, to the UE, a configuration identifying one or more Layer 1/Layer 2 (L1/L2) inter-cell mobility candidate target cells. The configuration identifies one or more actions to be performed by the UE with respect to each candidate target cell on determining BFD on the current serving cell and/or the one or more candidate target cells.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a flow chart illustrating a method in accordance with some embodiments;

FIG. 2 is a flow chart illustrating a method in accordance with some embodiments;

FIG. 3 shows an example of a communication system in accordance with some embodiments;

FIG. 4 shows a UE in accordance with some embodiments;

FIG. 5 shows a network node in accordance with some embodiments;

FIG. 6 is a block diagram of a host;

FIG. 7 is a block diagram illustrating a virtualization environment in which functions implemented by some embodiments may be virtualized; and

FIG. 8 shows a communication diagram of a host communicating via a network node with a UE over a partially wireless connection in accordance with some embodiments.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Certain aspects of this disclosure and their embodiments may provide solutions to one or more of the above-identified problems. For example, examples of this disclosure comprise a method at a UE capable of L1/L2 inter-cell mobility. In the example method, the UE receives a L1/L2 inter-cell mobility configuration, including one or more L1/L2 target candidate cell configurations for one or more target candidate cells, and wherein each included L1/L2 target candidate cell configuration includes a configuration to perform beam failure detection (BFD) on a set of reference signals belonging to the L1/L2 target candidate cell and a further configuration to perform BFR on the same L1/L2 target candidate cell.

Further example methods are described later in this disclosure, disclosing example ways on how the UE should perform beam failure detection (BFD) and beam failure recovery (BFR) once configured with a serving cell and one or more L1/L2 target candidate cells. The solutions include the following examples:
Solution 1: BFD+BFR only in the current serving cell
Solution 2: BFD+BFR in the current serving cell plus the L1/L2 target candidate cells
Solution 3: BFD+BFR done independently on the serving cell and the L1/L2 target candidate cells

Examples of this disclosure may further comprise the UE, upon reception of the target candidate cell configuration, performing one or more measurements to perform BFD monitoring on one or more Reference Signal(s) (RSs), such as SSBs and/or CSI-RSs. The one or more RSs may for example be configured in the bandwidth part (BWP) indicated in the received target candidate cell configurations.

In an example, a method at a User Equipment (UE) capable of L1/L2 inter-cell mobility is provided. The method comprises:
receiving a L1/L2 inter-cell mobility configuration, comprising at least one target candidate cell configuration,
   wherein the one target candidate cell configuration comprises:
      A configuration to perform BFD;
      A configuration to perform BFR once that a beam failure is triggered;
      An indication on which cell to perform BFD and BFR and what actions the UE should perform.
Performing BFD on the serving cell (and eventually also on one or more of the L1/L2 target candidate cells)
Upon detecting BFD, the UE performing one or more of the following actions:
   If BFD is detected on the serving cell, at least one of the following options can be pursued:
      The UE triggers BFR on the serving cell
      The UE triggers BFR on one of the L1/L2 target candidate cells.
      The UE execute L1/L2 inter-cell mobility on one of the configured L1/L2 target candidate cells
      The UE sends an indication over one or more L1/L2 target candidate cells to report BFD over the serving cell.
   If the BFD is detected on one or more of the L1/L2 target candidate cells, at least one of the following options can be pursued:
      The UE sends an indication over the serving cell to inform that BFD has been detected on one or more L1/L2 target candidate cells.
      The UE trigger BFR on the one or more L1/L2 target candidate cells in with BFD is detected

The method may in some examples further comprise obtaining an indication on what action to perform during BFD and BFR within the a L1/L2 inter-cell mobility configuration, comprising at least one target candidate cell configuration,

The method may in some examples further comprise obtaining an indication on what action to perform during BFD and BFR within the RRC message sent by the centralized unit (CU) and that comprises the a L1/L2 inter-cell mobility configuration,

The method may in some examples further comprise obtaining an indication on what action to perform during BFD and BFR in the L1/L2 inter-cell mobility execution command the UE receives.

In some examples, the indication comprises one or more of:
What the UE should do if BFD is detected over the serving cell;
What the UE should do if BFD is detected over one or more of L1/L2 target candidate cells
Whether BFD monitoring should only be performed over the serving cell
Whether BFD monitoring should be performed on the serving cell plus one or more of L1/L2 target candidate cells.
Whether BFR should be done only over the serving cell
Whether BFR can also be done on one or more L1/L2 target candidate cells

The method may in some examples further comprise performing one or more BFD monitoring on one or more Reference Signal(s) (RSs), such as SSBs and/or CSI-RS resource, wherein the one or more RSs are configured in the BWP indicated in the received target candidate cell configurations

This may reduce the connectivity interruption, signaling overhead, and also the power consumption of the UE and the network.

Some of the embodiments contemplated herein will now be described more fully with reference to the accompanying drawings. Embodiments are provided by way of example to convey the scope of the subject matter to those skilled in the art.

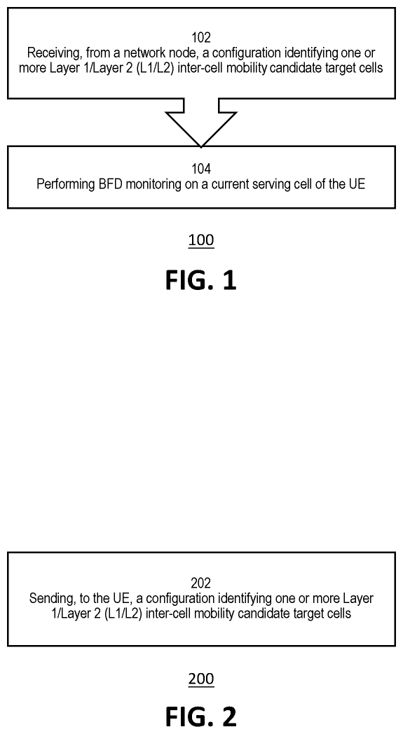

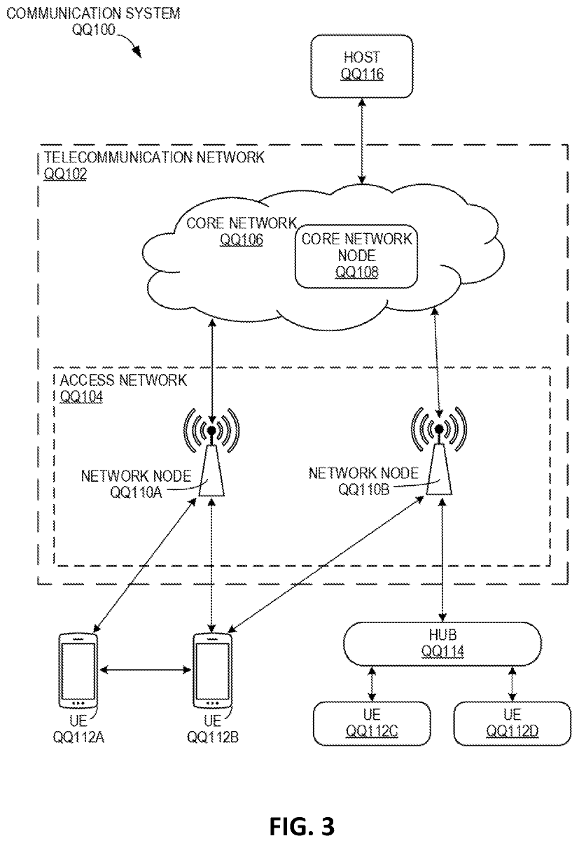

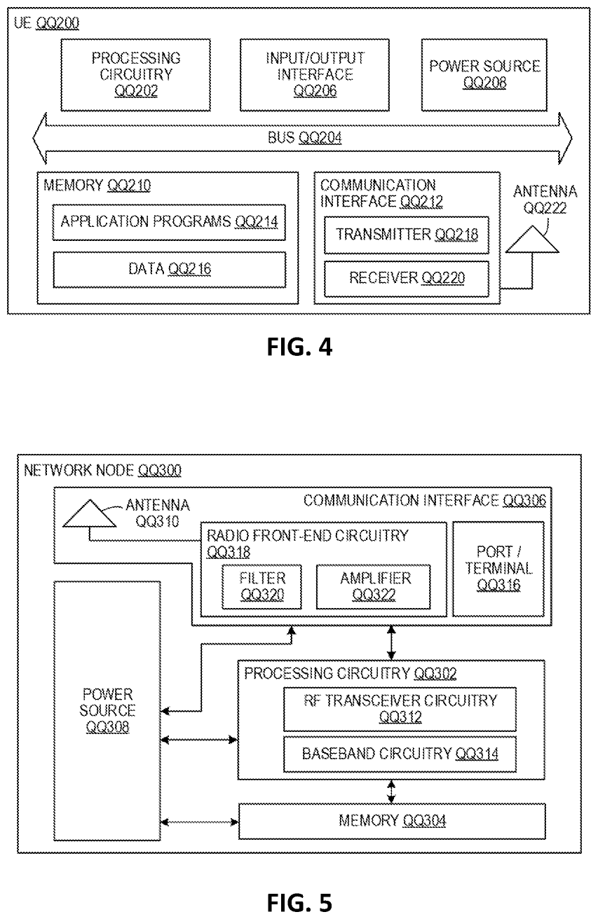

FIG. 1 depicts a method 100 in accordance with particular embodiments, such as for example a method performed by a user equipment (UE) for beam failure detection (BFD) monitoring. The method 100 may be performed by a UE or wireless device (e.g. the UE QQ112 or UE QQ200 as described later with reference to FIGS. 3 and 4 respectively). The method begins at step 102 with receiving, from a network node, a configuration identifying one or more Layer 1/Layer 2 (L1/L2) inter-cell mobility candidate target cells; and step 104 with performing BFD monitoring on a current serving cell of the UE.

In some examples, the configuration identifies one or more actions to be performed with respect to each candidate target cell on determining BFD on the current serving cell. In such examples, the method 100 may comprise performing the one or more actions on determining BFD on the current serving cell.

Performing BFD monitoring on the current serving cell of the UE in step 104 of the method 100 may comprise for example performing BFD monitoring only on the current serving cell of the UE. The method 100 may also in some examples comprise, on determining BFD on the current serving cell, performing beam failure recovery (BFR) on the current serving cell or one or more of the one or more candidate target cells. BFR may be performed only on the one or more of the one or more candidate target cells if results of measurements on all of one or more beams of the current serving cell are below a threshold, in some examples.

In some examples, executing L1/L2 inter-cell mobility to one of the candidate target cells may be performed if results of measurements on all of one or more beams of the current serving cell are below a threshold. In such examples, the method 100 may also comprise sending, on the one of the candidate target cells, an indication that BFD was determined on the serving cell of the UE.

The method 100 may in some examples comprise performing BFD monitoring on one or more of the one or more candidate target cells. The method 100 may also comprise, if BFD is determined, selecting one or more beams on the serving cell and/or one or more of the one or more candidate target cells. In some examples, the method 100 may also comprise, if BFD was determined on the current serving cell, performing BFR on one or more selected beams on the current serving cell.

If BFD was determined on one or more of the one or more candidate target cells, the method 100 may in some examples comprise performing BFR on one or more selected beams of the one or more of the one or more candidate target cells or executing L1/L2 inter-cell mobility to a selected beam on one of the one or more candidate target cells. An indication may be sent in some examples on the one of the one or more candidate target cells that BFD was determined on the serving cell of the UE. The method 100 may also comprise, in some examples, comprising selecting beams only on one or more of the one or more candidate target cells if results of measurements on all of one or more beams of the current serving cell are below a threshold. BFR on a beam on one of the one or more candidate target cells may be performed in some examples if results of measurements on all of one or more beams of the current serving cell are below a threshold.

In some examples, executing L1/L2 inter-cell mobility to the beam on the one of the one or more candidate target cells is performed if results of measurements on all of one or more beams of the current serving cell are below a threshold. In such examples, the method 100 may comprise sending, on the beam on the one of the one or more candidate target cells, an indication that BFD was determined on the serving cell of the UE.

The configuration identifying one or more L1/L2 inter-cell mobility candidate target cells may in some examples identify one or more actions to be performed with respect to each candidate target cell on determining BFD on that candidate target cell. In such examples, the method 100 may comprise performing the one or more actions to be performed with respect to one or the candidate target cells on determining BFD on that candidate target cell.

The configuration may in some examples comprise one or more RRC configurations, one or more cell group configurations, one or more SpCellConfig, one or more ServingCellConfigCommon, and/or one or more Physical Cell IDs (PCIs).

FIG. 2 depicts a method 200 in accordance with particular embodiments, such as for example a method performed by a network node for configuring a user equipment (UE) for beam failure detection (BFD) monitoring. The method 200 may be performed by a network node (e.g. the network node QQ110 or network node QQ300 as described later with reference to FIGS. 3 and 5 respectively), and the network node may in some examples be associated with a current serving cell of with the UE). The method begins at step 202 with sending, to the UE, a configuration identifying one or more Layer 1/Layer 2 (L1/L2) inter-cell mobility candidate target cells. The configuration identifies one or more actions to be performed by the UE with respect to each candidate target cell on determining BFD on the current serving cell and/or the one or more candidate target cells.

In some examples, the configuration includes an indication to the UE to perform BFD monitoring only on the current serving cell of the UE. The configuration may also include an indication to the UE to, on determining BFD on the current serving cell, perform beam failure recovery (BFR) on the current serving cell and/or on one or more of the one or more candidate target cells. Also in some examples, the configuration may also include an indication to the UE to perform BFR only on the one or more of the one or more candidate target cells if results of measurements on all of one or more beams of the current serving cell are below a threshold.

In some examples, the configuration includes an indication to the UE to, on determining BFD on the current serving cell, execute L1/L2 inter-cell mobility to one of the candidate target cells. The configuration may also include an indication to the UE to execute L1/L2 inter-cell mobility to one of the candidate target cells if results of measurements on all of one or more beams of the current serving cell are below a threshold.

The configuration may in some examples include an indication to the UE to perform BFD monitoring on one or more of the one or more candidate target cells. In such examples, the configuration may also include an indication to the UE to, if BFD is determined, select one or more beams on the serving cell and/or one or more of the one or more candidate target cells. Further, in some examples, the configuration may also include an indication to the UE to, if BFD was determined on the current serving cell, perform BFR on one or more selected beams on the current serving cell. Additionally or alternatively, the configuration may for example include an indication to the UE to, if BFD was determined on one or more of the one or more candidate target cells, perform BFR on one or more selected beams of the one or more of the one or more candidate target cells or execute L1/L2 inter-cell mobility to a selected beam on one of the one or more candidate target cells. In such examples, the configuration could also include an indication to the UE to select beams only on one or more of the one or more candidate target cells if results of measurements on all of one or more beams of the current serving cell are below a threshold.

In some examples, the configuration includes an indication to the UE to, on determining BFD on the serving cell, perform BFR on a beam on the serving cell and/or perform BFR on a beam on one of the one or more candidate target cells. In such examples, the configuration may also include an indication to the UE to, on determining BFD on the serving cell, perform BFR on a beam on one of the one or more candidate target cells if results of measurements on all of one or more beams of the current serving cell are below a threshold.

In some examples, the configuration includes an indication to the UE to, on determining BFD on the serving cell, execute L1/L2 inter-cell mobility to a beam on one of the one or more candidate target cells. In such examples, the configuration may also include an indication to the UE to, on determining BFD on the serving cell, execute L1/L2 inter-cell mobility to the beam on the one of the one or more candidate target cells if results of measurements on all of one or more beams of the current serving cell are below a threshold.

In at least some of the above examples, the configuration may also include an indication to the UE to, on determining BFD on one of the one or more candidate target cells, send, on the serving cell, an indication that BFD was determined on the one of the one or more candidate target cells.

Examples of this disclosure refer to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility or L1/L2 inter-cell mobility. These terms are used interchangeably in this disclosure. The basic principle is that the UE receives a lower layer signaling from the network indicating to the UE a change (or switch or activation) of its serving cell (e.g. change of PCell, from a source to a target PCell), wherein a lower layer signaling is a message/signaling of a lower layer protocol, which may be referred as a L1/L2 inter-cell mobility execution command. The change of serving cell (e.g. change of PCell) may also lead to a change in Scell(s) for the same cell group e.g. in case the command triggers the UE to change to another cell group configuration of the same type (e.g. another MCG configuration).

A lower layer protocol refers to a lower layer protocol in the air interface protocol stack compared to RRC protocol, e.g. Medium Access Control (MAC) is considered a lower layer protocol as it is “below” RRC in the air interface protocol stack, and in this case a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility; in addition, it may also increase the mobility robustness as the network may respond to faster changes in the channel conditions. Another relevant aspect in L1/L2 inter-cell mobility is that in multi-beam scenario, a cell can be associated to multiple SSBs, and during a half-frame, different SSBs may be transmitted in different spatial directions (i.e. using different beams, spanning the coverage area of a cell). Similar reasoning may be applicable to CSI-RS resources, which may also be transmitted in different spatial directions. Hence, in L1/L2 inter-cell mobility, the reception of a lower layer signaling indicates the UE to change from one beam in the serving cell, to another beam in a neighbour cell (which is a configured candidate cell), and by that changing serving cell.

Examples of this disclosure refer to the term target candidate configuration (used herein interchangeably with candidate target cell configuration, or a configuration for a candidate target cell) to refer to the configuration of a “L1/L2 inter-cell mobility candidate cell”, which is a cell the UE is configured with when configured with L1/L2 inter-cell mobility. That is a cell the UE can move to in a L1/L2 inter-cell mobility procedure, upon reception of a lower layer signaling. These cells may also be called candidate cell(s), candidates, mobility candidates, non-serving cells, additional cells, target candidate cell, target candidate, etc. This is a cell the UE may perform measurements on (e.g. CSI measurements) so that the UE reports these measurements to the network node or RAN node, and network may make a decision on which beam (e.g. Transmission Configuration Indicator (TCI) state) and/or cell the UE is to be switched to. A L1/L2 inter-cell mobility candidate cell may be a candidate to be a target PCell or PSCell, or an SCell of a cell group (e.g. master cell group (MCG) SCell).

The actual target candidate configuration and its exact content and/or structure of this information element (IE) and/or embedded message may be called an RRC model for the candidate configuration, or simply RRC model. A target candidate configuration comprises the configuration which the UE needs to operate accordingly when it performs (executes) L1/L2 inter-cell mobility execution to that target candidate cell, upon reception of the lower layer signaling indicating a L1/L2 based inter-cell mobility to that target candidate cell (which becomes the target cell and the current (new) PCell, or an SCeII in a serving frequency). The UE may be configured with multiple target candidate cells, so a Candidate distributed unit (DU) generates and sends to the CU multiple configuration(s). The target candidate configuration comprises at least parameters of a serving cell (or multiple serving cells), comprising one or more of the groups of parameters within the IE SpCellConfig (or the IE SCellConfig, in the case of a Secondary Cell).

Some examples of how the signaling could be implemented in RRC for the target candidate configuration are described as so called RRC models for L1/L2 based inter-cell mobility:
a) RRC Reconfiguration per candidate cell. In this case the UE receives multiple (a list of) RRC messages (i.e., RRCReconfiguration message) within a single RRCReconfiguration message. Each RRCReconfiguration message identify a target candidate configuration that is stored by the UE and is applied/used/activated when receiving the lower layer signaling for L1/L2 inter-cell mobility. This model enables the full flexibility, as in L3 reconfigurations, for the target node to modify/release/keep any parameter/field in the RRCReconfiguration message such as measurement configuration, bearers, etc.
b) CellGroupConfig per candidate cell. With this model the UE receives within an RRCReconfiguration a list of CellGroupConfig IEs and each one of them identify a target candidate configuration. Each CellGroupConfig IE is stored at the UE and is applied/used/activated when receiving the lower layer signaling for L1/L2 inter-cell mobility. This model allows the target node to modify/release/keep any parameter/field that is part of a CellGroupConfig IE while the rest of the RRCReconfiguration message (that is where the CellGroupConfig IE is received by the UE) remain unchanged. This means that e.g., measurement configuration, bearers, and security remain the same and are not changed by the target node.
c), d), and e) “K” SpCellConfig or “K” ServingCellConfigCommon, or both per cell. With this model the UE receives either “K” SpCellConfig per cell (option c), “K” ServingCellConfigCommon per cell (option e), or “K” SpCellConfig and “K” ServingCellConfigCommon per cell (option d) as a target candidate configuration. This solution provides only minimum flexibility for the target node since only cell-specific parameters (e.g., bandwidth parts, downlink, and uplink configurations) can be modified/released/kept. K may be for example the number of candidate target cells.
f) “K” PCI in the same PCell. With this model multiple PCIs are configured for the same Transmission Configuration Indicator (TCI) state configuration where each PCI identify a target candidate configuration. This is approach that provide no flexibility at all since all the parameters/fields used for configuring a target candidate configuration are fixed and only a change of PCI, scrambling Id, and C-RNTI is allowed to the target node.

The L1/L2 inter-cell mobility configuration may correspond for example to a field and/or information element defined in RRC protocol (e.g. in ASN.1 format) comprising one or more target candidate cell configuration(s). The L1/L2 inter-cell mobility configuration may comprise multiple target candidate cell configuration(s), in case the UE is configured with multiple target candidate cell(s) for L1/L2 inter-cell mobility. That L1/L2 inter-cell mobility configuration may be included in an RRCReconfiguration message (as defined in TS 38.331), or an RRC Resume message the UE receives e.g. during a state transition to RRC_CONNECTED.

The L1/L2 inter-cell mobility configuration may be generated for example by a Central Unit (CU), e.g. gNB-CU, and include information generated and transmitted from a Candidate Distributed Unit (DU), such as the target candidate cell configuration and/or a measurement configuration indicating the UE to perform measurements on reference signaling (RSs), e.g. SSBs and/or CSI-RS resources, of a target candidate cell, for reporting to the network to assist L1/L2 inter-cell mobility execution decisions.

The target candidate cell configuration comprises for example the configuration based on which the UE operates in the target candidate cell if that cell is indicated as a target cell in the L1/L2 inter-cell mobility execution command.

Further, “BFD monitoring” is referred to in this disclosure as for example a procedure in which the UE loses the connection with the beam from which is currently served, and it try to recover the connection over one of the other available beams. In case the UE is not able to restore the connection via none of the available beams, the phase of “BFD declaration” is entered (e.g. where BFD is determined as indicated above). Upon “BFD declaration,” the next phase is referred to as beam failure recovers, i.e. “BFR”. When “BFR” is triggered, the UE for example performs the RACH procedure according to the configuration received within the serving or candidate cell configurations (or generally on the best beam candidate on the serving cell and/or one or more of the in order to target candidate cell(s).

Particular example embodiments are now described for illustrative purposes.

In a set of example embodiments, the UE receives a L1/L2 inter-cell mobility configuration, comprising at least one target candidate cell configuration (e.g. an RRCReconfiguration, or a CellGroupConfig or an SpCellConfig per target candidate), wherein the one target candidate cell configuration includes a configuration to perform the BFD procedure and a further configuration to execute the BFR procedure. At the same time, the UE is already configured with a BFD and BFR configurations according to the cell configuration that is currently used in the serving cell.

Based on the BFD and BFR configurations received in the configuration related to the serving cell in which is currently operating, in case the UE loses the connection with the beam that is currently using (towards the serving cell), the UE perform the BFD monitoring only in the current serving cell. In case BFD is declared/determined:
In one embodiment the UE performs BFR on one of the beams of the serving cell selected during the BFD procedure. How the UE selects the best beams can be e.g., based on the reference signal received power (RSRP), signal to interference and noise ratio (SINR), reference signal received quality (RSRQ), received signal strength indicator (RSSI) or some other metric measured by the UE in that beam
In another embodiment, the UE performs BFR on one of the L1/L2 target candidate cell(s). In this case, the BFR can be performed to the best beam among all the ones available among all the L1/L2 target candidate cell(s). The best beam among the L1/L2 target candidate cells can be determined based on the L1 measurements used to trigger the L1/L2 mobility. Alternatively, the BFR can be performed to more than one beam belong to different target candidate cell(s). In one alternative, the BFR on one or more of the L1/L2 target candidate cells is performed if the beams of the serving cell are all measured to be below a certain threshold according to some metric, e.g. RSRP, SINR, RSRQ or RSSI.
In another embodiment, the UE performs L1/L2 inter-cell mobility execution on one of the L1/L2 target candidate cell(s). In one alternative, this is triggered if the beams of the serving cell are all measured to be below a certain threshold according to some metric, e.g. RSRP, SINR, RSRQ or RSSI. In this case, the UE will avoid initiating the BFR procedure but instead will switch from the serving cell to one of the configured L1/L2 target candidate cell(s). In particular, when performing the switching the UE may trigger, according to the previously received one target candidate cell configuration, the RACH procedure toward one of the configured L1/L2 target candidate cell(s) or may simply start to send a first UL message (e.g., either scheduling request (SR) or data). After performing the switching, the UE may also send a further indication to the “new serving cell” that the switch was due to the BFD detected on the “old serving cell”. Here the indication may include one or more of the following:
   The cell ID of the old serving cell
   The configuration ID of the old serving cell
   The TCI state ID of the old serving cell

Note that in this example, the UE keeps only one instance of the BFD with relating timers and counter that is relative to the serving cell. The UE does not keep any BFD timers and counters to any of the L1/L2 target candidate cell(s).

In another set of example embodiments, the UE receives a L1/L2 inter-cell mobility configuration, comprising at least one target candidate cell configuration (e.g. an RRCReconfiguration, or a CellGroupConfig or an SpCellConfig per target candidate), wherein the one target candidate cell configuration includes a configuration to perform the BFD procedure and a further configuration to execute the BFR procedure. At the same time, the UE is already configured with a BFD and BFR configurations according to the cell configuration that is currently used in the serving cell.

Based on the BFD and BFR configurations received in the configuration related to the serving cell in which is currently operating, in case the UE loses the connection with the beam that is currently using (towards the serving cell), the UE perform the BFD monitoring by considering both beams of the serving cell and one or more of the L1/L2 target candidate cell(s). In this case, in case the BFD is detected, there are difference on whether the selected beams after the BFD detection belongs to the serving cell or one of the L1/L2 target candidate cell(s). In particular:
If the selected beams after the BFD detection belongs to the serving cell:
   In one embodiment the UE performs BFR on one of the beams of the serving cell selected during the BFD procedure. How the UE selects the best beams can be e.g., based on the RSRP, SINR, RSRQ, or RSSI or some other metric measured by the UE in that beam
   In another embodiment, the UE performs L1/L2 inter-cell mobility execution on one of the L1/L2 target candidate cell(s). In one alternative, this is triggered if the beams of the serving cell are all measured to be below a certain threshold according to some metric, e.g. RSRP, SINR, RSRQ or RSSI. In this case, the UE will avoid initiating the BFR procedure but instead will switch from the serving cell to one of the configured L1/L2 target candidate cell(s). In particular, when performing the switching the UE may trigger, according to the previously received one target candidate cell configuration, the RACH procedure toward one of the configured L1/L2 target candidate cell(s) or may simply start to send a first UL message (e.g., either SR request or data). After performing the switching, the UE may also send a further indication to the “new serving cell” that the switch was due to the BFD detected on the “old serving cell”. Here the indication may include one or more of the following:
      The cell ID of the old serving cell
      The configuration ID of the old serving cell
      The TCI state ID of the old serving cell
If the selected beams after the BFD detection belongs to one of the L1/L2 target candidate cell(s):
   In one embodiment, the UE performs BFR on one of the L1/L2 target candidate cell(s). In this case, the BFR can be performed to the best beam among all the ones available among all the L1/L2 target candidate cell(s). Alternatively, the BFR can be performed to more than one beam belong to different target candidate cell(s).
   In another embodiment, the UE performs L1/L2 inter-cell mobility execution on one of the L1/L2 target candidate cell(s). In this case, the UE will avoid initiating the BFR procedure but instead will switch from the serving cell to one of the configured L1/L2 target candidate cell(s). In particular, when performing the switching the UE may trigger, according to the previously received one target candidate cell configuration, the RACH procedure toward one of the configured L1/L2 target candidate cell(s) or may simply start to send a first UL message (e.g., either SR request or data). After performing the switching, the UE may also send a further indication to the “new serving cell” that the switch was due to the BFD detected on the “old serving cell”. Here the indication may include one or more of the following:
      The cell ID of the old serving cell
      The configuration ID of the old serving cell
      The TCI state ID of the old serving cell

Note that in this solution the UE keep only one instance of the BFD with relating timers and counter that is common to the serving cell but also to all the L1/L2 target candidate cell(s). Therefore, the overall set of beam in which the BFD and BFR procedures are executed include both beams from the serving cells and beams of the L1/L2 target candidate cell(s) that the UE got within the a L1/L2 inter-cell mobility configuration, comprising at least one target candidate cell configuration.

In another set of example embodiments, the UE receives a L1/L2 inter-cell mobility configuration, comprising at least one target candidate cell configuration (e.g. an RRCReconfiguration, or a CellGroupConfig or an SpCellConfig per target candidate), wherein the one target candidate cell configuration includes a configuration to perform the BFD procedure and a further configuration to execute the BFR procedure. At the same time, the UE is already configured with a BFD and BFR configurations according to the cell configuration that is currently used in the serving cell.

Based on the BFD and BFR configurations received in the configuration related to the serving cell in which is currently operating, in case the UE loses the connection with the beam that is currently using (towards the serving cell), the UE may perform the BFD monitoring independently on the serving cell and one or more of the L1/L2 target candidate cell(s). In this case, in case the BFD and BFR procedure are running independently at the UE even if there are differences on whether a BFD is declared on the serving cell or on one or more of the L1/L2 target candidate cell(s). In particular:
If BFD is declared on the serving cell:
   In one embodiment the UE performs BFR on one of the beams of the serving cell selected during the BFD procedure. How the UE selects the best beams can be e.g., based on the RSRP, SINR, RSRQ, or RSSI or some other metric measured by the UE in that beam
   In another embodiment, the UE performs BFR on one of the L1/L2 target candidate cell(s). In this case, the BFR can be performed to the best beam among all the ones available among all the L1/L2 target candidate cell(s). The best beam among the L1/L2 target candidate cells can be determined based on the L1 measurements used to trigger the L1/L2 mobility. Alternatively, the BFR can be performed to more than one beam belong to different target candidate cell(s). In one alternative, the BFR on one or more of the L1/L2 target candidate cells is performed if the beams of the serving cell are all measured to be below a certain threshold according to some metric, e.g. RSRP, SINR, RSRQ or RSSI.
   In another embodiment, the UE performs L1/L2 inter-cell mobility execution on one of the L1/L2 target candidate cell(s). In this case, the UE will avoid initiating the BFR procedure but instead will switch from the serving cell to one of the configured L1/L2 target candidate cell(s). In one alternative, this is triggered if the beams of the serving cell are all measured to be below a certain threshold according to some metric, e.g. RSRP, SINR, RSRQ or RSSI. In particular, when performing the switching the UE may trigger, according to the previously received one target candidate cell configuration, the RACH procedure toward one of the configured L1/L2 target candidate cell(s) or may simply start to send a first UL message (e.g., either SR request or data). After performing the switching, the UE may also send a further indication to the “new serving cell” that the switch was due to the BFD detected on the “old serving cell”. Here the indication may include one or more of the following:
      The cell ID of the old serving cell
      The configuration ID of the old serving cell
      The TCI state ID of the old serving cell
   In another embodiment, the UE may trigger a report to be sent over one of the L1/L2 target candidate cell(s). According to this, the reporting may imply the UE executing L1/L2 inter-cell mobility to one of more of the L1/L2 target candidate cell(s), or the UE may just send a lower layer signaling to one or more L1/L2 target candidate cell(s) to indicate about the BFD detected over the serving cell. The report may include an indication that BFD has been detected on the serving cell and also one or more of the following:
      The cell ID of the old serving cell
      The configuration ID of the old serving cell
      The TCI state ID of the old serving cell
If BFD is declared on one or more of the L1/L2 target candidate cell(s):
   In one embodiment, the UE may trigger a report to be sent over the serving cell. According to this, the report may be sent over RRC or over a lower layer signaling (e.g., MAC CE, DCI, L1 signaling). The report may include an indication that BFD has been detected on one or more of the L1/L2 target candidate cell(s):and also one or more of the following:
      One of more cell IDs of the one or more of the L1/L2 target candidate cell(s):
      One or more configuration IDs of the one or more of the L1/L2 target candidate cell(s):
      One or more TCI state IDs of the one or more of the L1/L2 target candidate cell(s).
   In one embodiment, the UE performs BFR on the L1/L2 target candidate cell in which the BFD has been detected. In this case, the BFR can be performed to the best beam of the L1/L2 target candidate cell in which the BFD has been detected.
   In another embodiment, the UE may trigger a report to be sent over one of the L1/L2 target candidate cell(s) in which BFD has not been detected. According to this, the reporting may imply the UE just sending a lower layer signaling to one or more L1/L2 target candidate cell(s), in which BFD has not been detected, to indicate about the BFD detected over one of more of the L1/L2 target candidate cell(s). The report may include an indication that BFD has been detected on the serving cell and also one or more of the following:
      One of more cell IDs of the one or more of the L1/L2 target candidate cell(s):
      One or more configuration IDs of the one or more of the L1/L2 target candidate cell(s):
      One or more TCI state IDs of the one or more of the L1/L2 target candidate cell(s).

Note that in this solution the UE keep independent BFD and BFR configurations and instances (e.g., with relating timers and counter) one for the serving cell and one for each of the configured L1/L2 target candidate cell(s). Therefore, once the BFD timer and counters (once the BFD is detected) should also be reset or restarted on the cell in which the BFD has been detected, whereas the other BFD timers and counters related to the other cell should continue running

FIG. 3 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 3, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 4 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality. For example, the processing circuitry QQ202 may be configured to cause the UE QQ202 to perform the methods as described with reference to FIG. 1.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 5 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIG. 2.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 5 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

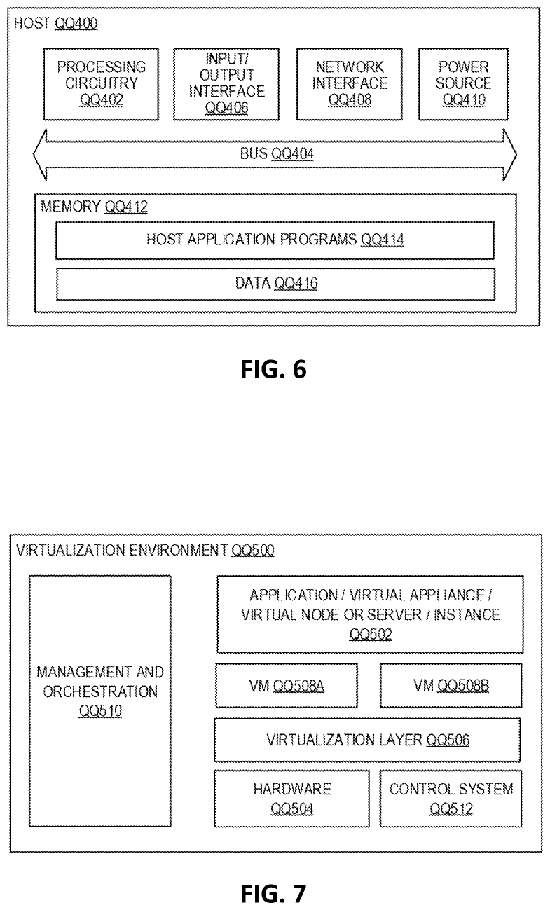

FIG. 6 is a block diagram of a host QQ400, which may be an embodiment of the host QQ116 of FIG. 3, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 4 and 5, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown.

The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 7 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

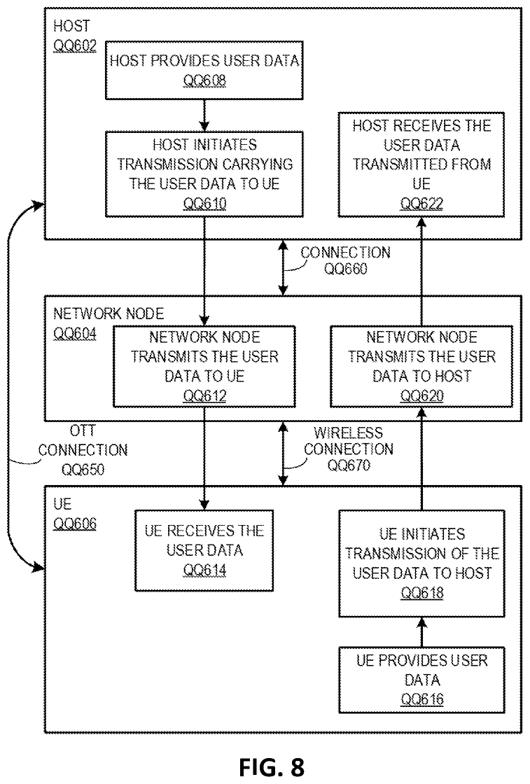

FIG. 8 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 3 and/or UE QQ200 of FIG. 4), network node (such as network node QQ110a of FIG. 3 and/or network node QQ300 of FIG. 5), and host (such as host QQ116 of FIG. 3 and/or host QQ400 of FIG. 6) discussed in the preceding paragraphs will now be described with reference to FIG. 8.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 3) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606.

The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve UE connectivity and/or power consumption.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602.

The measurements may be implemented in that software causes messages to be transmitted, in particular empty or ‘dummy’ messages, using the OTT connection QQ650 while monitoring propagation times, errors, etc.

This disclosure also includes the following enumerated embodiments.

### Group A Embodiments

1. A method performed by a user equipment (UE) for beam failure detection (BFD) monitoring, the method comprising:
   receiving, from a network node, a configuration identifying one or more Layer 1/Layer 2 (L1/L2) inter-cell mobility candidate target cells; and
   performing BFD monitoring on a current serving cell of the UE.
2. The method of embodiment 1, wherein the configuration identifies one or more actions to be performed with respect to each candidate target cell on determining BFD on the current serving cell.
3. The method of embodiment 2, comprising performing the one or more actions on determining BFD on the current serving cell.
4. The method of any of embodiments 1 to 3, comprising performing BFD monitoring on the one or more candidate target cells.
5. The method of embodiment 4, wherein the configuration identifies one or more actions to be performed with respect to each candidate target cell on determining BFD on that candidate target cell.
6. The method of embodiment 5, comprising performing the one or more actions to be performed with respect to one or the candidate target cells on determining BFD on that candidate target cell.
7. The method of any of embodiments 1 to 6, wherein the network node comprises a base station centralized unit (CU), distributed unit (DU) or core network node.
8. The method of any of embodiments 1 to 3, wherein performing BFD monitoring on the current serving cell of the UE comprises performing BFD monitoring only on the current serving cell of the UE.
9. The method of embodiment 8, comprising, on determining BFD on the current serving cell, performing beam failure recovery (BFR) on the current serving cell.
10. The method of embodiment 8 or 9, comprising, on determining BFD on the current serving cell, performing beam failure recovery (BFR) on one or more of the one or more candidate target cells.
11. The method of embodiment 10, comprising performing BFR only on the one or more of the one or more candidate target cells if results of measurements on all of one or more beams of the current serving cell are below a threshold.
12. The method of embodiment 8, comprising, on determining BFD on the current serving cell, executing L1/L2 inter-cell mobility to one of the candidate target cells.
13. The method of embodiment 12, comprising executing L1/L2 inter-cell mobility to one of the candidate target cells if results of measurements on all of one or more beams of the current serving cell are below a threshold.
14. The method of embodiment 12 or 13, comprising sending, on the one of the candidate target cells, an indication that BFD was determined on the serving cell of the UE.
15. The method of embodiment 14, wherein the indication identifies a cell ID, configuration ID and/or TCI state ID of the serving cell.
16. The method of any of embodiments 1 to 7, comprising performing BFD monitoring on one or more of the one or more candidate target cells.
17. The method of embodiment 16, comprising, if BFD is determined, selecting one or more beams on the serving cell and/or one or more of the one or more candidate target cells.
18. The method of embodiment 17, comprising, if BFD was determined on the current serving cell, performing BFR on one or more selected beams on the current serving cell.
19. The method of embodiment 17 or 18, comprising, if BFD was determined on one or more of the one or more candidate target cells, performing BFR on one or more selected beams of the one or more of the one or more candidate target cells.
20. The method of embodiment 17 or 18, comprising, if BFD was determined on one or more of the one or more candidate target cells, executing L1/L2 inter-cell mobility to a selected beam on one of the one or more candidate target cells.
21. The method of embodiment 20, comprising sending, on the one of the one or more candidate target cells, an indication that BFD was determined on the serving cell of the UE.
22. The method of embodiment 21, wherein the indication identifies a cell ID, configuration ID and/or TCI state ID of the serving cell.
23. The method of any of embodiments 19 to 22, comprising selecting beams only on one or more of the one or more candidate target cells if results of measurements on all of one or more beams of the current serving cell are below a threshold.
24. The method of embodiment 16, comprising determining BFD on the serving cell.
25. The method of embodiment 24, comprising performing BFR on a beam on the serving cell.
26. The method of embodiment 24, comprising performing BFR on a beam on one of the one or more candidate target cells.
27. The method of embodiment 26, comprising performing BFR on a beam on one of the one or more candidate target cells if results of measurements on all of one or more beams of the current serving cell are below a threshold.
28. The method of embodiment 24, comprising executing L1/L2 inter-cell mobility to a beam on one of the one or more candidate target cells.
29. The method of embodiment 28, comprising executing L1/L2 inter-cell mobility to the beam on the one of the one or more candidate target cells if results of measurements on all of one or more beams of the current serving cell are below a threshold.
30. The method of embodiment 28 or 29, comprising sending, on the beam on the one of the one or more candidate target cells, an indication that BFD was determined on the serving cell of the UE.
31. The method of embodiment 30, wherein the indication identifies a cell ID, configuration ID and/or TCI state ID of the serving cell.
32. The method of any of embodiments 16 and 24 to 31, comprising determining BFD on one of the one or more candidate target cells.
33. The method of embodiment 32, comprising sending, on the serving cell, an indication that BFD was determined on the one of the one or more candidate target cells.
34. The method of embodiment 33, wherein the indication identifies a cell ID, configuration ID and/or TCI state ID of the one of the one or more candidate target cells.
35. The method of any of embodiments 1 to 34, wherein the configuration is received in one or more Radio Resource Control (RRC) messages.
36. The method of any of embodiments 1 to 35, wherein the configuration comprises one or more RRC configurations, one or more cell group configurations, one or more SpCellConfig, one or more ServingCellConfigCommon, and/or one or more Physical Cell IDs (PCIs).
37. The method of any of embodiments 1 to 36, wherein the configuration indicates, for each candidate target cell, a bandwidth part (BWP) for a reference signal for the candidate target cell.
38. The method of any of the previous embodiments, further comprising:
   providing user data; and
   forwarding the user data to a host via the transmission to the network node.

### Group B Embodiments

39. A method performed by a network node for configuring a user equipment (UE) for beam failure detection (BFD) monitoring, the method comprising:
   sending, to the UE, a configuration identifying one or more Layer 1/Layer 2 (L1/L2) inter-cell mobility candidate target cells.
40. The method of embodiment 39, wherein the configuration identifies one or more actions to be performed by the UE with respect to each candidate target cell on determining BFD on the current serving cell.
41. The method of embodiment 39 or 40, wherein the configuration includes an indication to the UE to perform BFD monitoring on the one or more candidate target cells.
42. The method of embodiment 41, wherein the configuration identifies one or more actions to be performed by the UE with respect to each candidate target cell on determining BFD on that candidate target cell.
43. The method of embodiment 42, wherein the configuration includes an indication to the UE to perform the one or more actions to be performed with respect to one or the candidate target cells on determining BFD on that candidate target cell.
44. The method of any of embodiments 39 to 43, wherein the network node comprises a base station centralized unit (CU), distributed unit (DU) or core network node.
45. The method of any of embodiments 39 to 40, wherein the configuration includes an indication to the UE to perform BFD monitoring only on the current serving cell of the UE.
46. The method of embodiment 45, wherein the configuration includes an indication to the UE to, on determining BFD on the current serving cell, perform beam failure recovery (BFR) on the current serving cell.
47. The method of embodiment 45 or 46, wherein the configuration includes an indication to the UE to, on determining BFD on the current serving cell, perform beam failure recovery (BFR) on one or more of the one or more candidate target cells.
48. The method of embodiment 47, wherein the configuration includes an indication to the UE to perform BFR only on the one or more of the one or more candidate target cells if results of measurements on all of one or more beams of the current serving cell are below a threshold.
49. The method of embodiment 45, wherein the configuration includes an indication to the UE to, on determining BFD on the current serving cell, execute L1/L2 inter-cell mobility to one of the candidate target cells.
50. The method of embodiment 49, wherein the configuration includes an indication to the UE to execute L1/L2 inter-cell mobility to one of the candidate target cells if results of measurements on all of one or more beams of the current serving cell are below a threshold.
51. The method of embodiment 49 or 50, wherein the configuration includes an indication to the UE to send, on the one of the candidate target cells, an indication that BFD was determined on the serving cell of the UE.
52. The method of embodiment 51, wherein the indication identifies a cell ID, configuration ID and/or TCI state ID of the serving cell.
53. The method of any of embodiments 39 to 44, wherein the configuration includes an indication to the UE to perform BFD monitoring on one or more of the one or more candidate target cells.
54. The method of embodiment 53, wherein the configuration includes an indication to the UE to, if BFD is determined, select one or more beams on the serving cell and/or one or more of the one or more candidate target cells.
55. The method of embodiment 54, wherein the configuration includes an indication to the UE to, if BFD was determined on the current serving cell, perform BFR on one or more selected beams on the current serving cell.
56. The method of embodiment 54 or 55, wherein the configuration includes an indication to the UE to, if BFD was determined on one or more of the one or more candidate target cells, perform BFR on one or more selected beams of the one or more of the one or more candidate target cells.
57. The method of embodiment 54 or 55, wherein the configuration includes an indication to the UE to, if BFD was determined on one or more of the one or more candidate target cells, execute L1/L2 inter-cell mobility to a selected beam on one of the one or more candidate target cells.
58. The method of embodiment 57, wherein the configuration includes an indication to the UE to send, on the one of the one or more candidate target cells, an indication that BFD was determined on the serving cell of the UE.
59. The method of embodiment 58, wherein the indication identifies a cell ID, configuration ID and/or TCI state ID of the serving cell.
60. The method of any of embodiments 56 to 59, wherein the configuration includes an indication to the UE to select beams only on one or more of the one or more candidate target cells if results of measurements on all of one or more beams of the current serving cell are below a threshold.
61. The method of embodiment 53, wherein the configuration includes an indication to the UE to, on determining BFD on the serving cell, perform BFR on a beam on the serving cell.
62. The method of embodiment 53, wherein the configuration includes an indication to the UE to, on determining BFD on the serving cell, perform BFR on a beam on one of the one or more candidate target cells.
63. The method of embodiment 62, wherein the configuration includes an indication to the UE to, on determining BFD on the serving cell, perform BFR on a beam on one of the one or more candidate target cells if results of measurements on all of one or more beams of the current serving cell are below a threshold.
64. The method of embodiment 53, wherein the configuration includes an indication to the UE to, on determining BFD on the serving cell, execute L1/L2 inter-cell mobility to a beam on one of the one or more candidate target cells.
65. The method of embodiment 64, wherein the configuration includes an indication to the UE to, on determining BFD on the serving cell, execute L1/L2 inter-cell mobility to the beam on the one of the one or more candidate target cells if results of measurements on all of one or more beams of the current serving cell are below a threshold.
66. The method of embodiment 64 or 65, wherein the configuration includes an indication to the UE to, on determining BFD on the serving cell, send, on the beam on the one of the one or more candidate target cells, an indication that BFD was determined on the serving cell of the UE.
67. The method of embodiment 66, wherein the indication identifies a cell ID, configuration ID and/or TCI state ID of the serving cell.
68. The method of any of embodiments 53 and 61 to 67, wherein the configuration includes an indication to the UE to, on determining BFD on one of the one or more candidate target cells, send, on the serving cell, an indication that BFD was determined on the one of the one or more candidate target cells.
69. The method of embodiment 68, wherein the indication identifies a cell ID, configuration ID and/or TCI state ID of the one of the one or more candidate target cells.
70. The method of any of embodiments 39 to 69, wherein the configuration is sent to the UE in one or more Radio Resource Control (RRC) messages.
71. The method of any of embodiments 39 to 70, wherein the configuration comprises one or more RRC configurations, one or more cell group configurations, one or more SpCellConfig, one or more ServingCellConfigCommon, and/or one or more Physical Cell IDs (PCIs).
72. The method of any of embodiments 39 to 71, wherein the configuration indicates, for each candidate target cell, a bandwidth part (BWP) for a reference signal for the candidate target cell.
73. The method of any of embodiments 39 to 72, wherein the network node is associated with the current serving cell of the UE.
74. The method of any of the previous embodiments, further comprising:
   obtaining user data; and
   forwarding the user data to a host or a user equipment.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-48. (canceled)

49. A method performed by a user equipment (UE) for beam failure detection (BFD) monitoring, the method comprising:
receiving, from a network node, a configuration identifying one or more Layer 1/Layer 2 (L1/L2) inter-cell mobility candidate target cells;
performing BFD monitoring on a current serving cell of the UE;
determining BFD on the current serving cell; and
performing beam failure recovery (BFR) on a beam on the current serving cell or a beam on one of the one or more candidate target cells, or executing L1/L2 inter-cell mobility to a beam on one of the one or more candidate target cells.

50. The method of claim 49, wherein the configuration identifies one or more actions to be performed with respect to each candidate target cell on determining BFD on the current serving cell, and the method comprises performing the one or more actions on determining BFD on the current serving cell.

51. The method of claim 49, wherein performing BFD monitoring on the current serving cell of the UE comprises performing BFD monitoring only on the current serving cell of the UE.

52. The method of claim 51, comprising, on determining BFD on the current serving cell, performing beam failure recovery (BFR) on the current serving cell or one or more of the one or more candidate target cells.

53. The method of claim 52, comprising performing BFR only on the one or more of the one or more candidate target cells responsive to results of measurements on all of one or more beams of the current serving cell being below a threshold.

54. The method of claim 49, wherein executing L1/L2 inter-cell mobility to one of the candidate target cells is performed responsive to results of measurements on all of one or more beams of the current serving cell being below a threshold.

55. The method of claim 49, wherein BFR on a beam on one of the one or more candidate target cells is performed responsive to results of measurements on all of one or more beams of the current serving cell being below a threshold.

56. The method of claim 49, wherein executing L1/L2 inter-cell mobility to the beam on the one of the one or more candidate target cells is performed responsive to results of measurements on all of one or more beams of the current serving cell being below a threshold.

57. The method of claim 56, further comprising sending, on the beam on the one of the one or more candidate target cells, an indication that BFD was determined on the serving cell of the UE.

58. The method of claim 49, comprising sending, on the serving cell, an indication that BFD was determined on the one of the one or more candidate target cells.

59. The method of claim 49, wherein the configuration identifies one or more actions to be performed with respect to each candidate target cell on determining BFD on that candidate target cell.

60. The method of claim 59, comprising performing the one or more actions to be performed with respect to one or the candidate target cells on determining BFD on that candidate target cell.

61. The method of claim 49, wherein the configuration comprises one or more RRC configurations, one or more cell group configurations, one or more SpCellConfig, one or more ServingCellConfigCommon, and/or one or more Physical Cell IDs (PCIs).

62. A method performed by a network node for configuring a user equipment (UE) for beam failure detection (BFD) monitoring, the method comprising:
sending, to the UE, a configuration identifying one or more Layer 1/Layer 2 (L1/L2) inter-cell mobility candidate target cells,
wherein the configuration identifies one or more actions to be performed by the UE with respect to each candidate target cell on determining BFD on the current serving cell and/or the one or more candidate target cells.

63. The method of claim 62, wherein the configuration includes an indication to the UE to perform BFD monitoring only on the current serving cell of the UE.

64. The method of claim 63, wherein the configuration includes an indication to the UE to, on determining BFD on the current serving cell, perform beam failure recovery (BFR) on the current serving cell and/or on one or more of the one or more candidate target cells.

65. The method of claim 64, wherein the configuration includes an indication to the UE to perform BFR only on the one or more of the one or more candidate target cells responsive to results of measurements on all of one or more beams of the current serving cell being below a threshold.

66. he method of claim 63, wherein the configuration includes an indication to the UE to, on determining BFD on the current serving cell, execute L1/L2 inter-cell mobility to one of the candidate target cells.

67. A user equipment (UE) for beam failure detection (BFD) monitoring, the UE comprising a processor and a memory, the memory containing instructions executable by the processor such that the UE is operable to:
receive, from a network node, a configuration identifying one or more Layer 1/Layer 2 (L1/L2) inter-cell mobility candidate target cells;
perform BFD monitoring on a current serving cell of the UE;
determine BFD on the current serving cell; and
perform BFR on a beam on the current serving cell or a beam on one of the one or more candidate target cells, or execute L1/L2 inter-cell mobility to a beam on one of the one or more candidate target cells.

68. A network node for configuring a user equipment (UE) for beam failure detection (BFD) monitoring, the network node comprising a processor and a memory, the memory containing instructions executable by the processor such that the network node is operable to:
send, to the UE, a configuration identifying one or more Layer 1/Layer 2 (L1/L2) inter-cell mobility candidate target cells,
wherein the configuration identifies one or more actions to be performed by the UE with respect to each candidate target cell on determining BFD on the current serving cell and/or the one or more candidate target cells.
